(19) United States
(12) Patent Application Publication
(10) Pub. No.: US 2013/0147093 A1
(43) Pub. Date: Jun. 13, 2013

(54) BENDING PVC PROFILES USING LASER AND PLC CONTROLLING SYSTEM

(71) Applicant: Uros Turanjanin, Kragujevac (RS)

(72) Inventor: Uros Turanjanin, Kragujevac (RS)

(21) Appl. No.: 13/818,311

(22) PCT Filed: Dec. 14, 2010
(86) PCT No.: PCT/RS10/00016

§ 371 Date: Feb. 22, 2013

(30) Foreign Application Priority Data
Aug. 23, 2010 (JP) P-2010/0372

(51) Int. Cl. B29C 35/02

(52) U.S. Cl. CPC B29C 35/0288
USPC 264/479

(57) ABSTRACT

PVC profile bending using laser and PLC controlling system is a part of the arched PVC joinery, where the bending of the PVC profiles is completely automatized thus removing any possible human error caused by operating the machine manually. PLC controlling system includes encoder with a wheel X (4) and encoder Y (6), which send the information about the rotating speed of the motor X (4.1) and Y (6.1) to the PLC unit, where the rotating speed of the motor X is controlled using regulator of frequency (41) which is, same as the terminal (7), connected to the PLC unit using bidirectional connection, Laser system set in the plastic box (3) includes laser emitter (3.1) which releases beam reflected by the mirror foil (14) set on the profile (10) back to the photodiodes (3.2) connected with the PLC unit which constantly makes the corrections regarding the middle point of the profile, caused by omitting done by the encoder with a wheel, which loses the measuring precision of the profile length during the bending process.

### TECHNICAL FIELD

The invention is integral part of arched PVC joinery and refers to the bending process of PVC profiles using laser and PLC controlling systems placed on the existing bending machine for AL and PVC profiles. Mentioned patent is a part of the bending technology of pipes, profiles or tubes; more precise, bending of the PVC profile is executed by passing of the profile between plastic rollers using the laser and PLC controlling system with which symmetrical and geometrically precise and accurate bending is achieved.

This bending field is adjusted for the special objects. MKP marks of the patent are: 21 D 7/08, B 21 D 9/10, B29 C 53/08, 53/84, E06B 1/28, B 29 K27/06.

1. Technical Problem

The invention completely solves new automatized bending process of PVC profiles using laser and PLC controlling systems which are installed on the existing bending, machine for PVC and AL profiles. PLC controlling system along with the laser system provides maximal geometrical accuracy and precision of the bent PVC profile in comparison with the usual, manually operated, bending process.

2. The state of Art

Up to now PVC profile bending has been executed using following methods:
Bending on glycerin oil is expensive and slow because, during the bending process, large number of outer and inner caterpillar treads is used and molds have to be readjusted for every different diameter. This technology is complicated and ecologically unhealthy because of the glycerin oil evaporations which influence health of a worker who is directly involved in the bending process.
PVC profile bending using hot air in the heating chamber is similar to the bending technology mentioned above, except that there are no glycerin oil evaporations but man is still directly involved in a very complicated bending process.
Bending machine for PVC profiles with heathers and rollers bends PVC profile with man still directly involved in the bending process, operating the machine manually, using controlling buttons, thus not achieving accurate and geometrically precise shape of the bent PVC profile, because human error factor is inevitable,

### Short Description of the Invention

Laser and PLC controlling system, independently and without human interference, controls entire bending process of PVC profile and thus symmetrical and geometrically precise bending of the PVC profile is achieved. In the existing bending technology man was operating the machine manually and was directly involved in the PVC profile bending process, where possible human error factor was inevitable and for the final product asymmetrical and geometrically inaccurate PVC arch could have been produced. Laser and PLC controlling systems are composed of the following elements:
Plastic box in which laser emitter and photodiodes which receive reflected laser beam from the profile are placed. Role of this laser and photodiodes is to send information to the PLC unit where the middle of the profile is during the process. In this way the position of the profile middle point is checked and thus any possible mistake of encoder wheel which measures the X-axis movement of the profile is corrected. Not using the laser beam during the bending process would cause asymmetrical bending of the profile on the right and left side from the middle.
PLC unit in which program for processing all the data is set,
Encoder for measuring the straightforward movement of the middle roller on the Y-axis, which is set at the end of the ball screw. This encoder sends information to the PLC unit how much did the middle roller move during the bending process.
Encoder with the wheel leaned on the PVC profile with the sole purpose of sending information to the PLC unit how much did the profile move on the X-axis during the bending process to the PLC unit
Terminal i.e. touch screen, where all the necessary parameters for bending are inserted. Those parameters are sent to the PLC unit for processing so that PLC can manage the automatic PVC profile bending process on the machine.
Regulator of frequency which regulates the number of rounds of the back rollers on the machine and ends information regarding this matter to the PLC unit.

### DESCRIPTION OF THE DRAWINGS

The invention solves completely automatized PVC profiles bending process managed with laser and PLC controlling system, set on the existing bending machine for AL and PVC profiles, and is presented in details in the following drawings:

FIG. 1—shows the starting position of the PVC profile bending process on the bending machine

FIG. 2—shows middle position of the PVC profile bending process on the bending machine

FIG. 3—shows end position of the PVC profile bending process on the bending machine

FIG. 4—shows way of marking PVC profile before bending

FIG. 5—shows first screen where all arch dimensions needed for calculating the length of the arch part are inserted.

FIG. 6—shows second screen where all bending parameters which directly influence the bending process of the PVC profile on the machine are inserted

FIG. 7—shows third, working screen, where, along with the others, buttons for starting and ending the automatized bending process on the machine are set.

FIG. 8—shows the working scheme of the laser and PLC controlling system set on the machine.

### DETAIL DESCRIPTION OF THE INVENTION

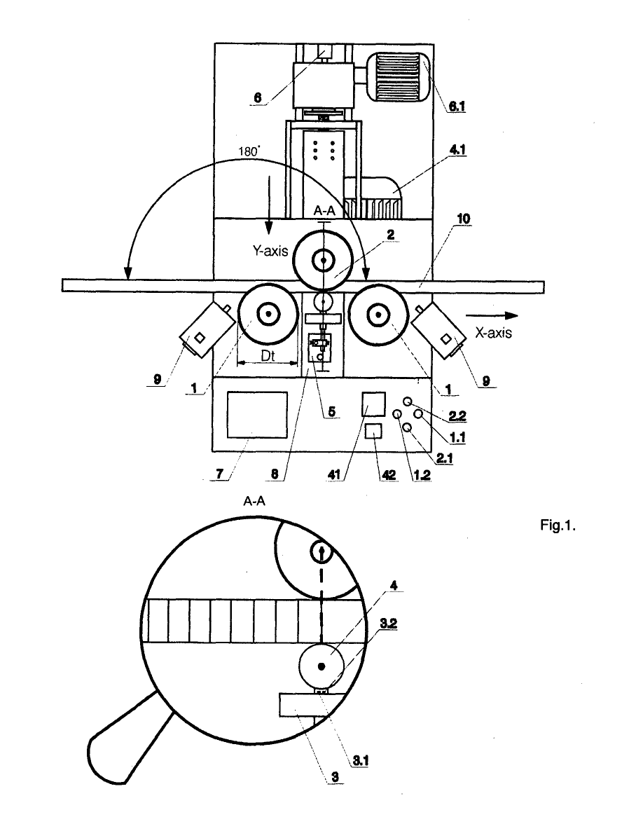

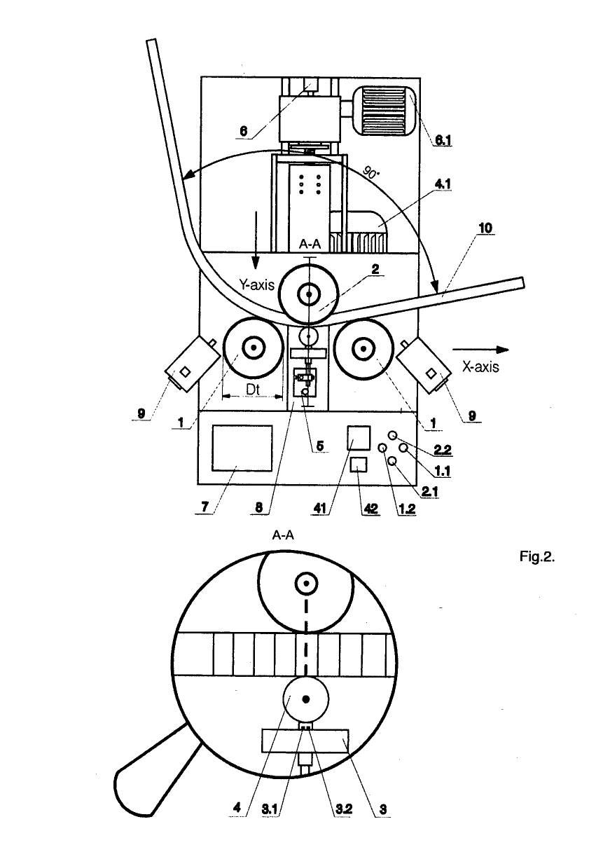

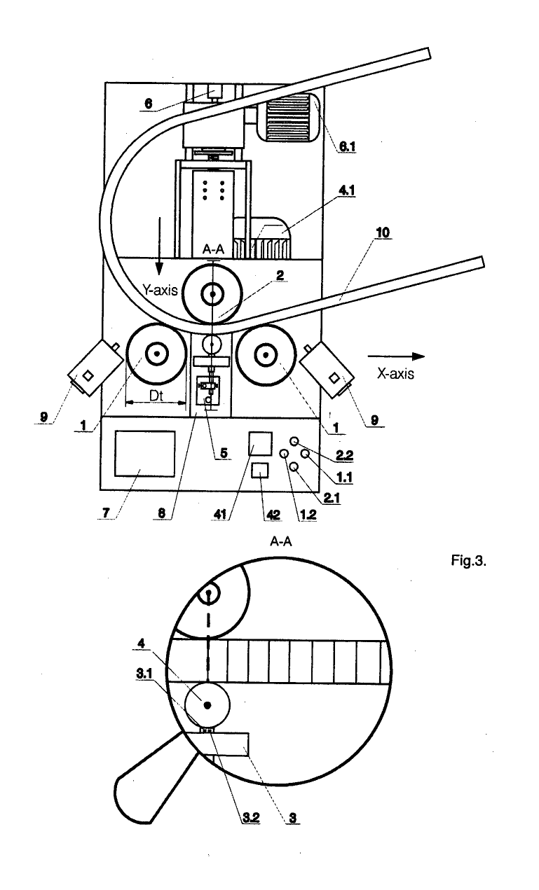

FIGS. 1, 2 and 3 show bending process of PVC profiles using the laser and PLC controlling system, which independently manages automatized bending process of the PVC profile on the machine without human interference in the bending process. PVC profile (10) showed on the FIGS. 1, 2 and 3 is in the starting, middle and end position, on the machine and is set between profiled plastic rollers (1 and 2) which are set in motion by motoreductor X (4.1) and motoreductor Y (6.1). Speed of the back rollers is controlled by regulator of frequency (41). Role of the boxes with hot air blowers (9) is to heat i.e. soften, the PVC profile where, with even heating, PVC profile reaches the temperature of 50-70 C, enough for plastic deformation and starting the PVC bending process.

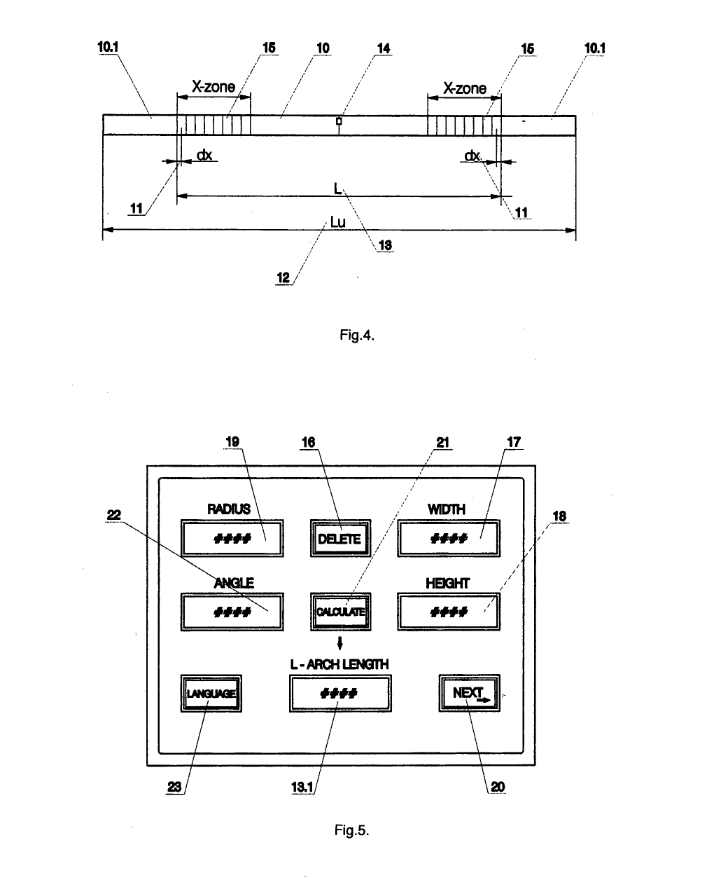

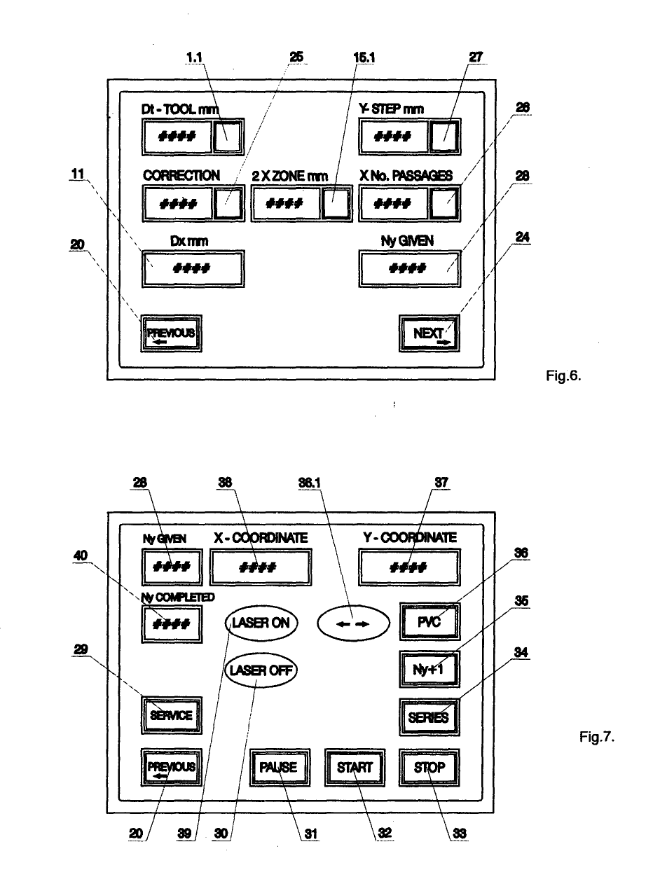

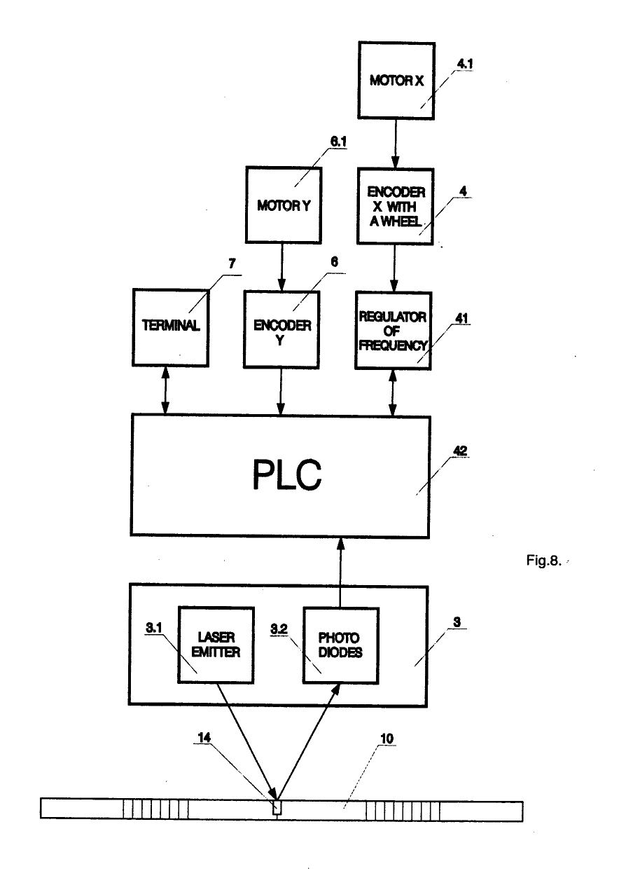

Using buttons 1.1, 1.2, 2.1, and 2.2, machine is operated before starting the automatized bending cycle. FIG. 4 shows marking procedure of the PVC profile which gives man standing next to the machine an easier way of following and controlling the automatized bending process on the machine. Procedure of marking the profile starts with marking the middle of the profile using felt-tip pen, and on that point mirror foil cut on the dimensions 7×7 mm, is placed, attached with self-adhesive tape. Role of the mirror foil is to receive and reflect laser beam back to the photodiodes set in the plastic box which combines these components into laser system for controlling the measurement of the profile length by encoder with the wheel. Afterwards, end points of total length of the arch part L are marked symmetrically on both sides of the PVC profile. On both sides of the profile, starting from the end points of arch part L and going towards the middle of the profile, so called “X zone” (15) is marked, which consists of eight equal fields with total length of 200 mm or nine lines with 25 mm space between them. X zone with 200 mm in length is always marked on left and right side of the profile, Total length of the profile Lu (12) represents the sum of the arch length and technological additions (10.1) placed on both sides of the profile, with minimal length of 250-300 mm on one side. “Dx” snare represents length for which movement path of the profile is shortened on every passing symmetrically on both sides in regard to the end points of the arch part L. Length of the “dx” space set between 9 lines of the “X-zone” is determined by the program in the PLC system, processing parameters received from the terminal (7) inserted by the operator. Terminal (7) where all data necessary for bending is inserted includes three different screens, FIGS. (5, 6 and 7). First screen (FIG. 5), is screen for data input, where field (17) is for the arch width, field (18) is for the arch height and by pressing the button (21) length of the arch part L is automatically calculated and shown in the field (13.1). Length of the arch part L ran also be mathematically calculated by inserting parameters in the fields (19) where radius of the arch is inserted and (22) where angle of the arch is inserted. Button (16) serves for erasing all of the incorrect parameters and button (23) serves for choosing the language on the display, Button (20) serves for switching from screen one to screen two. On the second screen (FIG. 6) parameters needed for bending the profile are inserted, and these parameters have direct influence on the manner of the automatized bending process of the profile. In the field (1.1) diameter of the tools (1 and 2) is inserted and that diameter usually ranges from 120 mm to 140 mm. In the field (27), called “Y step”, desired movement length of the middle roller (2) towards the PVC profile is inserted, and this value in millimeters usually ranges from 0.8 to 1.2 mm. Button (26) called “X No passages” shows how many times middle roller moves towards the profile on Y-axis every first, second or third time during the movement of the profile from left to right and vice versa. In the field (15.1) called “2×X-zone” sum of the desired length of the X-zone on both sides is inserted. Button (25) called “Correction” is for correction number which has direct influence on the result in the field (28) called “Ny Given” which shows given number of shifts of the middle roller towards the profile on Y-axis, more precise, shows how many times middle roller shifts towards the profile in every passing from left to right during the bending process. Button (20) serves for switching from screen 2 to screen 1 and button (24) serves for switching from screen 2 to screen 3. Third screen is working screen (FIG. 7) where the field (40) is placed, called “Ny”, which shows remaining number of shifts of the middle roller during the bending process. Field (38) called “X-coordinate” shows number of increments on X-axis, more precise, shows position of the profile in every moment during its movement from left to right. Field (37) called “Y-coordinate” shows number of increments on Y-axis and shows position of the middle roller in every moment, during its shifting to and from the profile. These fields serve as information of the exact position of the middle roller and profile and are necessary for the program set in the PLC unit.

Button (29) marked as “service” serves only for maintenance, so that service provider can check operational procedure of the machine during the bending process, where numerical values shown in increments are given. Purpose of the indicator light (39) named “laser on” is to inform the operator on every passing, with a short flash, that laser system functions properly and that the PLC unit received information from the photodiodes that the profile passed middle of its length at that moment. Purpose of the indicator light (39) named “laser off” is to warn the operator on every passing, with short flash, that photodiodes did not receive reflected laser beam and that PLC unit did not make the correction of the error caused by inconsistency of encoder wheel with the profile. In this case it is important to check if everything is in order with the mirror foil set on the profile which intermediates between laser beam and photodiodes.

Pressing the “PVC” button (36) for the first time during the bending process enables operator to stop the moving of the frontal tool towards the profile from time to time in order to execute re-crossing of the PVC profile which is recommended in order to suppress active forces which tend to straighten the profile during the bending process.

Blinking of the indicator light (36.1) warns that the process of re-crossing of the PVC profile is taking place at that moment. By pressing the “PVC” button again the previous automatized bending process continues by gradual movement of the frontal tool towards the profile. Pressing the button “Ny+1” starts an additional movement of the frontal tool towards the profile for the length entered in the field “Y step” (27) but only when there are no more available shifts left in the field “Ny Completed” (28). Button “START” (32) activates the bending process of the PVC profile.

By pressing the button “Series” (34) immediately after the bending process had started, the same bending process done on the previous profile can be executed if the desired dimensions of the arch are the same. Button “Pause” serves for stopping the bending process temporary, if there is any need for that. Pressing the same button again automatized bending process is resumed. Button “Stop” (33) serves for complete termination of the bending process and represents end of the cycle for the bent profile. Functioning scheme of the laser and PLC controlling system is shown in the FIG. (8) which shows plastic box (3) in which following elements are set: laser emitter (3.1) along with photodiodes (3.2) which receive the reflecting beam from the mirror foil (14) set on the middle of the PVC profile (10), shown in FIG. 4. When, during the bending process, profile is at the middle of its length, laser beam is transferred from the emitter to the photodiodes set in the plastic box via mirror foil thus informing the PLC unit that the profile is at the middle of its path at that moment. Using this information PLC unit is able to correct any possible error of the encoder, because there is a possibility that encoder wheel omits the counting if it does not fit correctly to the profile and thus disrupts correctness of the counting i.e. measuring of the distance traveled by the PVC profile on the X-axis during the bending process. Not using the laser system set in the plastic box would lead to an asymmetrical bending of the profile and for the consequence it would have uneven radius on left and right side of the PVC profile. PLC controlling unit is composed of the encoder with a wheel (4) which is set on the metal stand (5) which is attached to the sliding plate (8) with a screw clamp. Encoder with a wheel is leaned on the back side of the PVC profile so that it can send information to the PLC unit (42) about the rotating speed of the motor X (4.1). Rotating speed of the motor X is controlled using regulator of frequency (41) only, which is connected to the PLC unit with bidirectional connection, thus enabling it to exchange information with the PLC unit regarding the rotating speed of the back rollers on the machine. Measuring the rotating speed of the motoreductor (6.1) which executes shifting of the frontal roller towards the profile is done by the encoder (6). Encoder sends the information about the shifting speed of the frontal roller towards the profile to the PLC unit as a one-way signal for further processing. Terminal (7) is also connected to the PLC unit, with which it exchanges all necessary information previously inserted by operator, using bidirectional connection.

1. Bending PVC profile using laser and PLC controlling system is executed completely automatically thus excluding any possible human error from the process, because the system in question is very precise and reliable and manages entire bending process on the machine with absolute precision, wherein, PLC controlling system is additionally installed on the existing machine with three rollers. This PLC controlling system includes encoder with a wheel X (4) and encoder Y (6), which send the information about the rotating speed of the motor X (4.1) and Y (6.1) to the PLC unit, where the rotating speed of the motor X is controlled using regulator of frequency (41) which is, same as the terminal (7), connected to the PLC unit using bidirectional connection.

2. Bending PVC profile using laser and PLC controlling system is executed so that complete geometrical and symmetrical precision of the bent PVC profile is achieved, wherein, laser system set in a plastic box (3) is additionally installed on the existing machine with three rollers. This laser system set in a plastic box (3) includes laser emitter (3.1) and photodiodes (3.2) connected with the PLC unit which constantly makes the corrections regarding the middle point of the profile, caused by omitting done by the encoder with a wheel, which loses the measuring precision of the profile length during the bending process.
